(19) United States
(12) Patent Application Publication
(10) Pub. No.: US 2026/0091400 A1
(43) Pub. Date: Apr. 2, 2026

(54) Garden Hose Nozzle

(71) Applicant: SHIN TAI SPURT WATER OF THE GARDEN TOOLS CO., LTD., Changhua (TW)

(72) Inventor: Chin-Yuan Chen, Changhua (TW)

(21) Appl. No.: 18/963,701

(22) Filed: Nov. 28, 2024

(30) Foreign Application Priority Data
Sep. 30, 2024 (TW) 113210645

(51) Int. Cl. B05B 9/01

(52) U.S. Cl. CPC B05B 9/01

(57) ABSTRACT

A garden hose nozzle may include a handle and a spray tube, and the handle has a water inlet while the spray tube comprises a water outlet, and the handle and the spray tube are connected and communicated. A spray head is pivotally connected to the water outlet, and the spray pattern of the garden hose nozzle is adjusted during use by gripping and rotating the spray head. A plurality of raised patterns and a plurality of indented patterns are formed on the garden hose nozzle, and by arranging the raised patterns and the indented patterns in alternate patterns, a plurality of functioning portions are formed on at least both sides of the handle and around the outer periphery of the spray head.

### FIELD OF THE INVENTION

The present invention relates to a nozzle and more particularly to a garden hose nozzle with aesthetic appeal and better control.

### BACKGROUND OF THE INVENTION

In gardening, it is essential to regularly water plants to prevent them from dying due to lack of water. Since the planting area is often wide or located far from water source, watering is typically done by extending a hose. Although water flowing directly from the hose has a high intensity, it not only covers a small area but also damages and uproots plants. Thus, it is necessary to attach a spray nozzle to the end of the hose to realize a boarder spraying capability, thereby achieving the efficient and comprehensive irrigation.

Conventional garden hose nozzle commonly comprises a handle portion and a spray tube portion, and the handle portion has an inlet, while the spray tube portion features an outlet, and the handle portion and the spray tube portion are connected and communicated, so that water can flow through the inlet to the handle portion and the spray tube portion before being expelled through the outlet. The outlet is pivotally connected to a spray head, and the spray head is rotated to adjust the shape of water spray during operation.

However, the conventional garden hose nozzle has following disadvantages: (i) the garden hose nozzle lacks drainage functionality, and when the spray gun is held by its handle, the excessively wet or slippery surface caused by water can make it difficult to hold tightly, leading to poor handling during operation; and (ii) the lack of proper drainage functionality causes water to accumulate on the spray head during use, and this can make it challenging to grip and rotate the spray head securely due to either water adhesion on the head or slippery hands, and the rotation process often suffers from slippage, thereby causing inconvenient in use. Therefore, there remains a need for a new and improved design for a garden hose nozzle to overcome the problems presented above.

### SUMMARY OF THE INVENTION

The present invention provides a garden hose nozzle comprising a handle and a spray tube. The handle has a water inlet while the spray tube comprises a water outlet, and the handle and the spray tube are connected and communicated, so that the water is adapted to flow from the water inlet through the interiors of the handle and the spray tube to the water outlet. A spray head is pivotally connected to the water outlet, and the spray pattern of the garden hose nozzle is adjusted during use by gripping and rotating the spray head. A plurality of raised patterns and a plurality of indented patterns are formed on the garden hose nozzle, and by arranging the raised patterns and the indented patterns in alternate patterns, a plurality of functioning portions are formed on at least both sides of the handle and around the outer periphery of the spray head. The continuous alternate arrangement of the raised patterns and the indented patterns to form ups and downs shape on the surfaces of the handle and the spray head, so as to enhance the grip of the garden hose nozzle, to prevent slipping during use, to significantly contribute to the overall aesthetic appeal of the garden hose nozzle, and to provide three-dimensional visual effect.

Comparing with conventional garden hose nozzle, the present invention is advantageous because: (i) the drainage spaces are created between the handle and the palm of user, allowing the indented patterns to effectively and efficiently drain water from the garden hose nozzle, so that even if the garden hose nozzle is wet or the hands are slippery, the garden hose nozzle remains easy to hold and operate, providing better grip and stability during use; (ii) the design of the raised patterns and the indented patterns increases the contact surface area between the fingers and the spray head during the rotation process, thereby making the garden hose nozzle easier and more precise to adjust the settings of the garden hose nozzle; (iii) the combination of the raised patterns and the indented pattens creates a three-dimensional, layered gradient effect, enhancing the overall texture of the garden hose nozzle, and the design makes the garden hose nozzle more aesthetic, modern, and visual appeal; and (iv) the garden hose nozzle combines functions such as anti-slip, easy drainage, enhanced control, and aesthetic appeal, significantly increasing its desirability in the market.

### BRIEF DESCRIPTION OF THE DRAWINGS

FIG. 1 is a three-dimensional assembly view of a garden hose nozzle of the present invention.

FIG. 2 is a sectional view of the garden hose nozzle of the present invention.

FIG. 3 is a schematic view illustrating the garden hose nozzle of the present invention allows water to be quickly drained.

FIG. 4 is a schematic view illustrating a spray head of the garden hose nozzle of the present invention is gripped and rotated.

FIG. 5 is an enlarged schematic view illustrating the spray head of the garden hose nozzle of the present invention is gripped and rotated.

FIG. 6 is a three-dimensional assembly view of a second embodiment of a garden hose nozzle of the present invention.

FIG. 7 is a three-dimensional assembly view of a third embodiment of a garden hose nozzle of the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

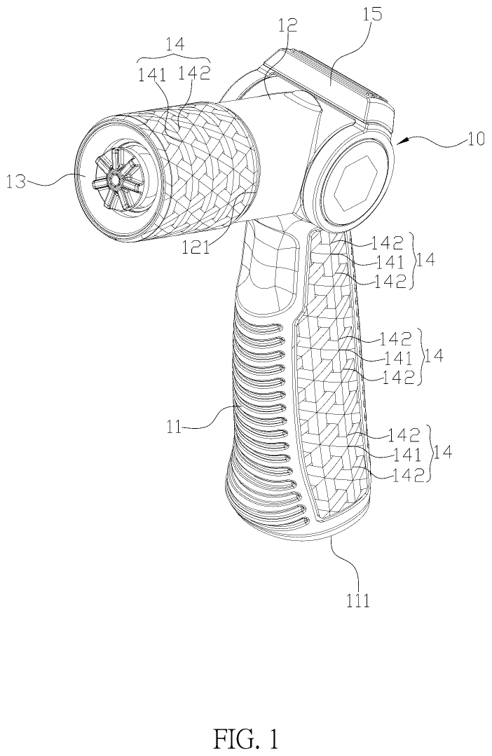

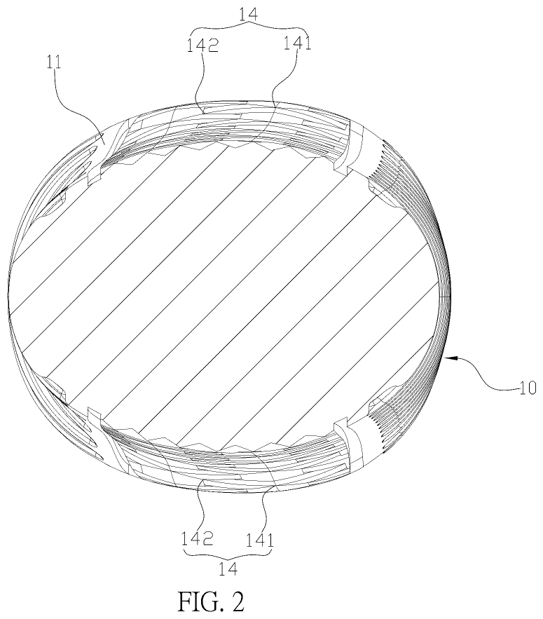

Referring to FIGS. 1 and 2, the present invention provides a garden hose nozzle (10) comprising a handle (11) and a spray tube (12). The handle (11) has a water inlet (111) while the spray tube (12) comprises a water outlet (121), and the handle (11) and the spray tube (12) are connected and communicated, so that the water is adapted to flow from the water inlet (111) through the interiors of the handle (11) and the spray tube (12) to the water outlet (121). A spray head (13) is pivotally connected to the water outlet (121), and the spray pattern of the garden hose nozzle (10) is adjusted during use by gripping and rotating the spray head (13). Moreover, a plurality of raised patterns (141) and a plurality of indented patterns (142) are formed on the garden hose nozzle (10), and by arranging the raised patterns (141) and the indented patterns (142) in alternate patterns, a plurality of functioning portions (14) are formed on at least both sides of the handle (11) and around the outer periphery of the spray head (13). The continuous alternate arrangement of the raised patterns (141) and the indented patterns (142) to form ups and downs shape on the surfaces of the handle (11) and the spray head (13), so as to enhance the grip of the garden hose nozzle, to prevent slipping during use, to significantly contribute to the overall aesthetic appeal of the garden hose nozzle (10), and to provide three-dimensional visual effect.

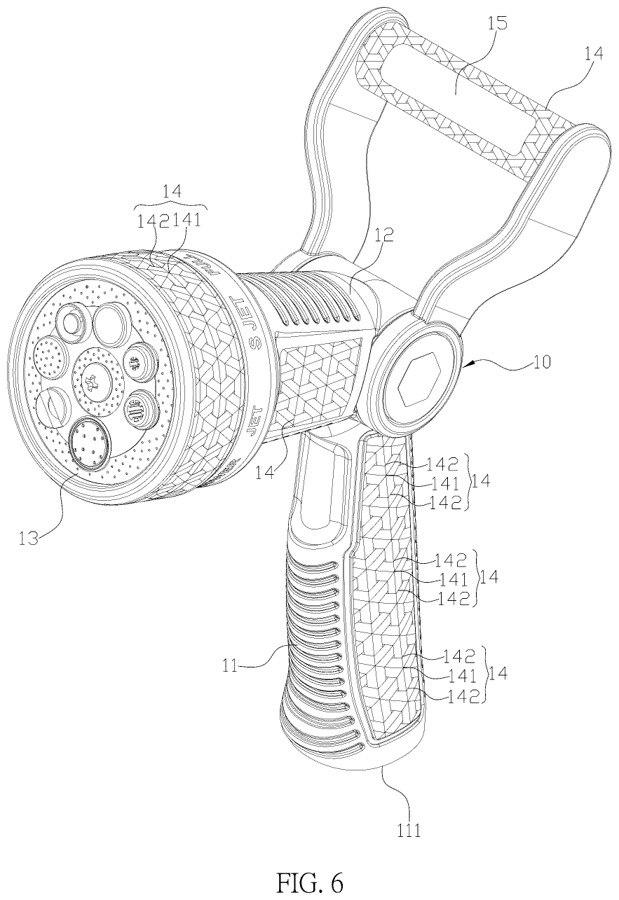

In one embodiment, the functioning portions (14) are formed on both sides of the spray tube (12) (as shown in FIG. 6).

In another embodiment, the spray head (13) is a three-stage spray head (as shown in FIGS. 1, 3 to 5).

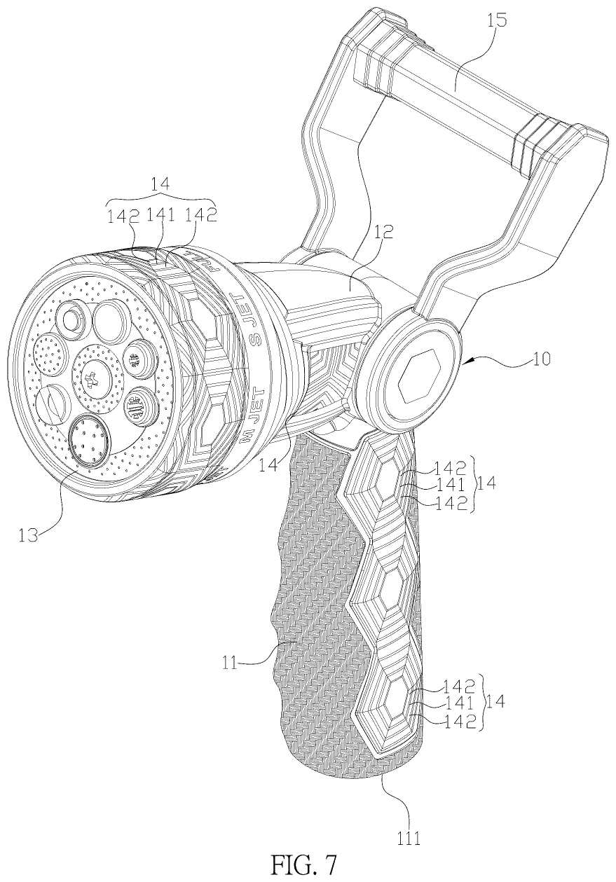

In still another embodiment, the spray head (13) is a multi-stage spray head with more than three stages such as five stages, seven stages, or eight stages (as shown in FIGS. 6 and 7).

In a preferred embodiment, the garden hose nozzle (10) is a trigger-operated garden hose nozzle having a control handle (15), and the control handle (15) is configured to drive a water valve located inside the garden hose nozzle (10) to adjust the water flow rate.

In a further embodiment, a plurality of functioning portions (14) are formed on the control handle (15) (as shown in FIG. 6).

In still a further embodiment, the functioning portions (14) are formed in a lattice structure (as shown in FIGS. 1 to 6) and arranged adjacent to the others, and the functioning portions (14) are connected to form a gradient-like three-dimensional pattern.

In an advantageous embodiment, the functioning portions (14) are formed in hexagonal shape (as shown in FIG. 7) and arranged adjacent to the others, and the functioning portions (14) are connected to form a gradient-like three-dimensional pattern.

In another advantageous embodiment, the functioning portions (14) are formed in various geometric patterns.

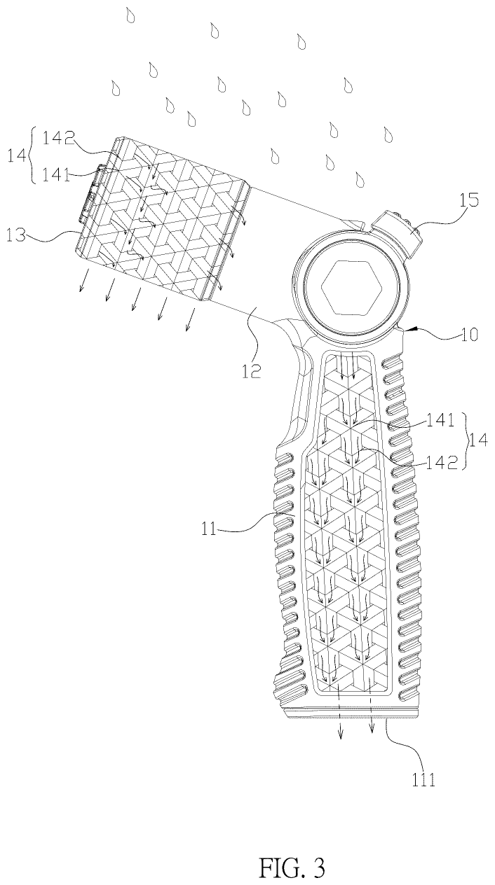

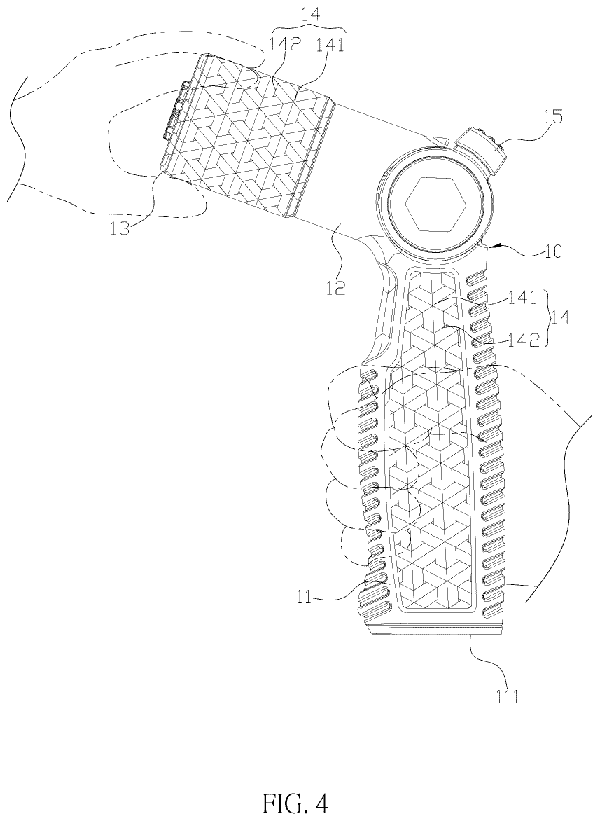

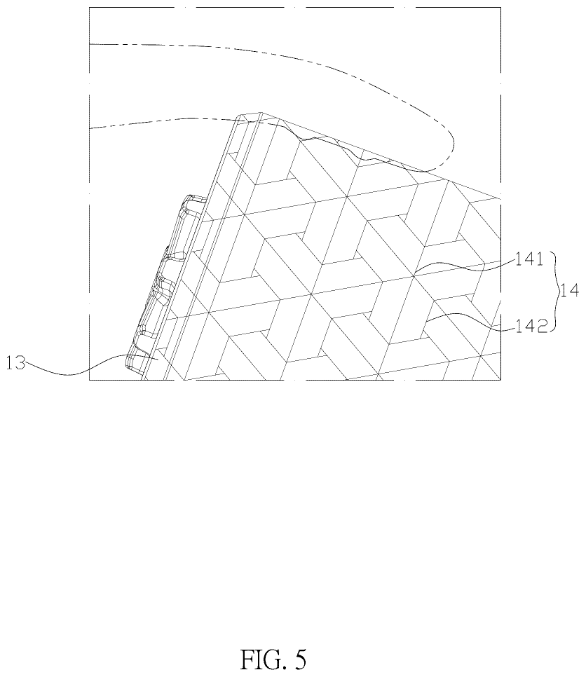

In actual application, the handle (11) is gripped by the palm of user, and the continuous ups and downs pattern of the raised patterns (141) and the indented patterns (142) is adapted to prevent the palm from full contact to the surface of the handle (11), so as to create drainage spaces between the handle (11) and the palm, allowing the indented patterns (142) to effectively and efficiently drain water from the garden hose nozzle (10) (as shown in FIG. 3). During the rotation of the spray head (13), the raised patterns (141) and the indented patterns (142) are adapted to enhance the contact surface area (as shown in FIGS. 4 and 5), so that even if the garden hose nozzle is wet or the hands are slippery, the spray head (13) can still be securely gripped and rotated. Thus, it allows for easier and more precise adjustment of the garden hose nozzle (10) settings, significantly improving its usability and convenience.

Comparing with conventional garden hose nozzle, the present invention is advantageous because: (i) the drainage spaces are created between the handle (11) and the palm, allowing the indented patterns (142) to effectively and efficiently drain water from the garden hose nozzle (10), so that even if the garden hose nozzle (10) is wet or the hands are slippery, it remains easy to hold and operate, providing better grip and stability during use; (ii) the design of the raised patterns (141) and the indented patterns (142) increases the contact surface area between the fingers and the spray head (13) during the rotation process, thereby making the garden hose nozzle (10) easier and more precise to adjust the settings of the garden hose nozzle (10); (iii) the combination of the raised patterns (141) and the indented pattens (142) creates a three-dimensional, layered gradient effect, enhancing the overall texture of the garden hose nozzle (10), and the design makes the garden hose nozzle (10) more aesthetic, modern, and visual appeal; and (iv) the garden hose nozzle (10) combines functions such as anti-slip, easy drainage, enhanced control, and aesthetic appeal, significantly increasing its desirability in the market.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A garden hose nozzle comprising a handle and a spray tube;
wherein the handle has a water inlet while the spray tube comprises a water outlet, and the handle and the spray tube are connected and communicated, so that the water is adapted to flow from the water inlet through the interiors of the handle and the spray tube to the water outlet; a spray head is pivotally connected to the water outlet, and the spray pattern of the garden hose nozzle is adjusted during use by gripping and rotating the spray head; a plurality of raised patterns and a plurality of indented patterns are formed on the garden hose nozzle, and by arranging the raised patterns and the indented patterns in alternate patterns, a plurality of functioning portions are formed on at least both sides of the handle and around the outer periphery of the spray head; the continuous alternate arrangement of the raised patterns and the indented patterns to form ups and downs shape on the surfaces of the handle and the spray head, so as to enhance the grip of the garden hose nozzle, to prevent slipping during use, to significantly contribute to the overall aesthetic appeal of the garden hose nozzle, and to provide three-dimensional visual effect.

2. The garden hose nozzle of claim 1, wherein the functioning portions are formed on both sides of the spray tube.

3. The garden hose nozzle of claim 1, wherein the spray head is a three-stage spray head.

4. The garden hose nozzle of claim 1, wherein the spray head is a multi-stage spray head with more than three stages.

5. The garden hose nozzle of claim 1, wherein the garden hose nozzle is a trigger-operated garden hose nozzle having a control handle.

6. The garden hose nozzle of claim 1, wherein the garden hose nozzle is a trigger-operated garden hose nozzle having a control handle, and a plurality of functioning portions are formed on the control handle.

7. The garden hose nozzle of claim 1, wherein the functioning portions are formed in a lattice structure and arranged adjacent to the others, and the functioning portions are connected to form a gradient-like three-dimensional pattern.

8. The garden hose nozzle of claim 1, wherein the functioning portions are formed in hexagonal shape and arranged adjacent to the others, and the functioning portions are connected to form a gradient-like three-dimensional pattern.
